(19) United States
(12) Patent Application Publication
(10) Pub. No.: US 2004/0090861 A1
(43) Pub. Date: May 13, 2004

(54) Container stirring mechanism

(76) Inventor: George A. S. Kitson, Winnipeg (CA)

Correspondence Address: ADE & COMPANY, 1700-360 MAIN STREET, WINNIPEG, MB, R3C3Z3, CA

(21) Appl. No.: 10/652,565

(22) Filed: Sep. 2, 2003

Related U.S. Application Data
(60) Provisional application No. 60/407,233, filed on Sep. 3, 2002.

(51) Int. Cl. B01F 7/18

(52) U.S. Cl. 366/244; 366/253; 366/306

(57) ABSTRACT

A stirring mechanism for a container, the container having an interior for receiving a liquid, comprises a lid on a top end of the container, a hand driven handle on the lid and a contoured stirring member extending from the handle into the container arranged to be driven by the handle within the container for mixing the liquid therein.

### FIELD OF THE INVENTION

The present invention relates to a container stirring mechanism more particularly a container having a manual stirring mechanism.

### BACKGROUND

Over the years there has been a rapidly growing concern for healthy eating habits fuelling an increased consumption of healthy liquids. Most of these liquids require mixing or stirring. The fibres or particles stored within a pitcher or jug for convenient consumption tend to gravitate to the bottom of the pitcher if left immobile for any amount of time. Attempts have been make to incorporate a stirring apparatus into a lid of a pitcher.

Examples of such stirring or mixing pitchers are described in U.S. Pat. Nos. 5,407,270, 6,086,240, 4,967,939 and in Canadian Patents 1,275,816 and 2,247,212

Most of the inventions do work in theory and in practice but many fail to be practical, consumer friendly and consumer familiar lacking consumer appeal in two or more areas of inspection.

### SUMMARY

According to the present invention there is provided a stirring mechanism for a container, the container having an interior for receiving a liquid, comprises:

a lid on a top end of the container;

a hand driven handle on the lid, and;

a contoured stirring member extending from the handle into the container arranged to be driven by the handle within the container for mixing the liquid therein.

The present invention provides a stirring apparatus that is familiar to the consumer, is easily disassembled for cleaning, effectively stirs liquids with minimal effort and does not require the lid to be removed or the container to be shaken for the liquid to be stirred or agitated.

The invention is an open-ended cylinder pitcher with handle and pour spout, also included is a adequately fitting lid with stirring apparatus which provides an improved and familiar means to manually stir liquids. The use of familiar items inventively combined enables a user to stir the pitchers contents with vigour and enthusiasm but will achieve maximum effects with little effort. Disassembly for cleaning is minimally required but easily achieved.

The cylinder pitcher at the open end is sealed with a lid which has a slightly convex radius allowing any weight to be evenly distributed over the entire surface. A flute elongated downwards is located at the center point of the lid, offering an opening and support for the spoon shaped utensil. This stirring utensils axis is bent creating an angle within the pitcher which allows the spoon shaped end to reach the cylinders containing wall at the base of the pitcher and is manually driven by a handle and its assembly located on the outside of the lid extending out from the center and will turn 360 degrees. This handle and assembly has a flip radius of 180 plus degrees allowing the entire handle assembly to be used to drive the spoon shaped utensil and then be stored in a recessed cavity moulded into the lid.

The use of different plastic ingredients and content with varying properties such as flexibility, durability, and texture are still being determined.

### BRIEF DESCRIPTION OF THE DRAWINGS

In the accompanying drawings, which illustrate an exemplary embodiment of the present invention:

FIG. 1 is an isometric view of the present invention.

FIG. 2 is a vertical cross section along the lines 4-4 of FIG. 1.

FIG. 3 is a horizontal cross section along the lines 3-3 of FIG. 2.

FIG. 4 is an isometric view of a second embodiment of the present invention.

FIG. 5 is a side elevational view of a second embodiment of the present invention.

### DETAILED DESCRIPTION

Referring to the accompanying drawings, there is illustrated a cylinder style pitcher 5 with an “I” type handle 6 which joins to pitcher 5 at two points, a pour spout 7 and a slightly concave base 8. The pitcher open end is fitted with a slightly convex lid 9 which features include two pour openings 10a and 10b, a recessed semi-circular contour 11, an inner sleeve 12 which embodies the entire inner circumference of container 5 open end, a rib 13 which circumferences the entire inner sleeve 12 and a elongated flute 14, as best illustrated in FIG. 2, located at the lids 9 center. A stirring apparatus consisting of a handle knob 15, a handle body 16 and the handle rod 17. A stirring utensil stem 18, the utensils spoon shaped end 19 and the fitted female end 20 of which is held in place by a grommet ring 21.

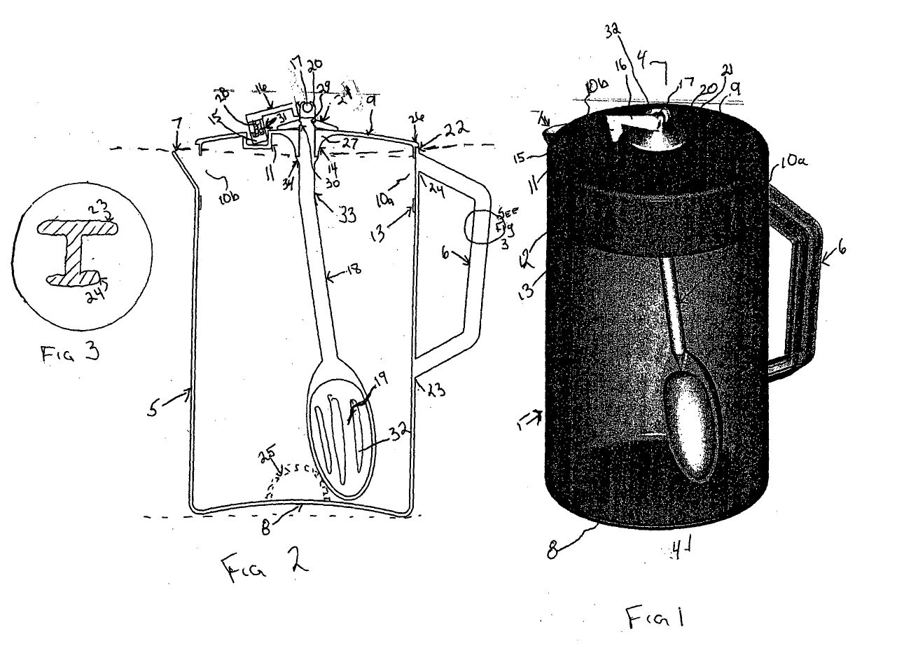

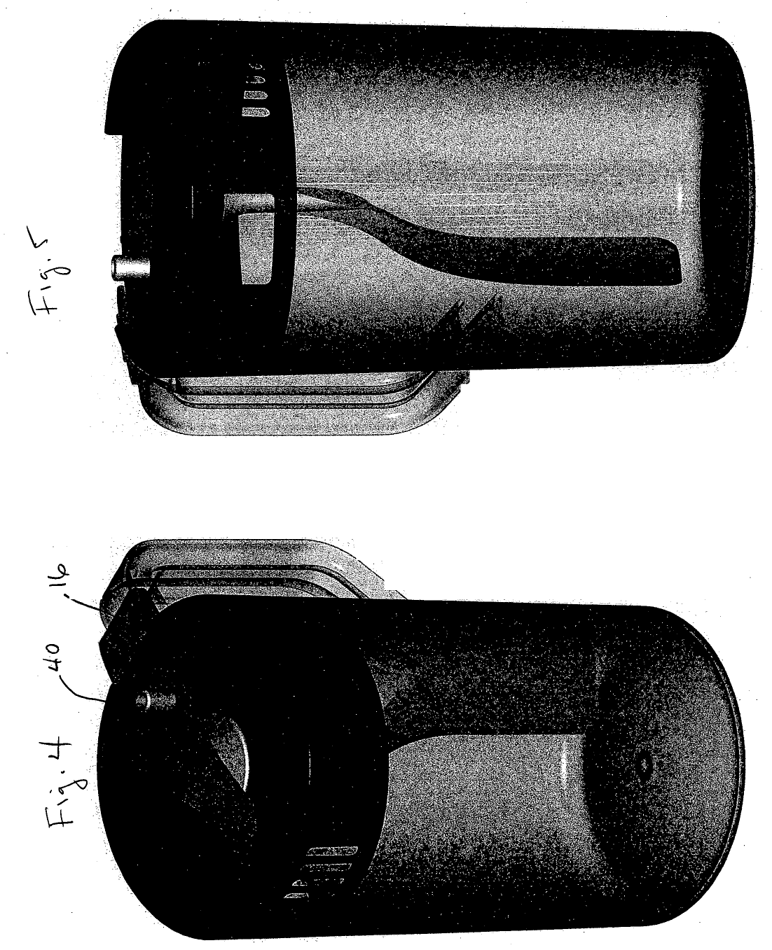

A description of the invention part by part making reference to illustration FIG. 2 and FIG. 1 and FIG. 3 where necessary. The pitcher where the containing walls form a cylinder 5. The bottom end is enclosed using a slightly concave base 8. A handle 6 which is joined at two locations, 24 which is the inside face of the “I” (see FIG. 3) and 23 which is the outside face of “I” (see FIG. 3) shaped handle 6. The top end is considered the open end which is highlighted as a ledge 22. A pour spout 7 is positioned adjacent to the handle 6 and is simply a “U” shape interruption in the pitcher's cylinder 5 open end ledge 22.

Possible embodiments without illustration for the cylinder pitcher 5 include (A) a raised contour 25 (FIG. 2) into the pitcher base 8 at the most center point. (B) Textures for cylinder pitcher embodiment may very from clear to semi-translucent to foggy. (C) Handle 6 “I” frame may accommodate a device near joining point 24 and pitchers ledge 22 used to help hold the lid 9 into place. (D) The “I” frame handle 6 may become more symmetrical or rounded at the inside and or outside surfaces. (E) Ridges for finger placement may also be incorporated into the inside surface or the “I” frame. (F) Angles and bend locations in handle 6 “I” frame may vary slightly from illustrations.

The lid 9 has a slightly convex surface used to distribute weight over the entire surface is fitted to close the open end of pitcher 5. The lids 9 outer most edges 26 rest on the pitchers 5 open end ledge 22. The lid 9 inner sleeve 12 is host to two pour openings 10a which is a grate style opening and 10b which is an open gate opening. Inner sleeve 12 also has a rib 13 used to make tightened contact and secure a sealed snug fit to the inside of pitcher 5 containing walls. A flute 14 which is center on the lid 9 and is elongated downward into the pitcher offers an opening for the stirring apparatus. To offer support to the flute 14 a flange 27 (see FIG. 2) of excess material is incorporated spreading any stress or resistance over a larger area. The lid 9 surface has a semi-circumference contour 11 which follows some of the 360 degree turning radius of stirring handle knob 15. When the stirring assembly is not in use the handle knob 15 of the assembly is stored in the semi-circumference contour 11.

Possible embodiments without illustration for the lid 9. (G) Rib 13 of inner sleeve 12 may be placed in two locations, first location as shown in FIG. 2 on the bottom of inner sleeve 12 and a second location at the top of inner sleeve 12 allowing the rib to seal just under the pitchers 5 ledge 22 again being able to circumference the entire surface without a break as is the rib 13. (H) Flute 14 flange 27 excess material may encompass the entire outer circumference of the flute 14 or be formed as individual legs spaced apart from each other until the outer circumference of the flute 14 has been surrounded. (I) A rib may be added to the inside of the flute 14 to replace the grommet 21 and its ring 29. The lid 9 surface at the center point may also have to be raised to accommodate the ring inside flute 14. (J) Finger sized indentations placed in the vicinity of outer edge 22 of lid 9 may be incorporated to allow a sense of grip when turning the lid 9 to pour positions 10a or 10b. (K) exact positions of pour openings 10a and 10b may not be exactly as shown in illustrations.

The grommet 21 is used to secure the spoon shaped utensil into a fixed position minimizing resistance and undesirable movement of the stirring apparatus. The grommet is moulded with a ring 29 which holds the stirring utensil stem 18 into place by fitting around the indent 30 of the stirring utensil stem 18, restricting its vertical movement. The grommet 21 is slightly bevelled allowing for some flexibility, which allows the fitting of grommet ring 29 of grommet 21 to be pulled apart from indent 30 of stirring utensil stem 18.

The stirring handle 16 has a flip radius of 180 degrees plus to allow the stirring handle 16 to be used to rotate the stirring utensil 18, 360 degrees and then when not in use it can be flipped 180 degrees to position it's stirring handle knob into semi-circumference contour 11. To allow easy manual rotation the stirring handle 16 is fitted with a handle knob 15 which also rotates in full 360 degree circles to a close peg fastener 28 which applies outward pressure on the inside of handle knob 15 at a rib 31 on the inside of handle knob 15 which helps secure its position on the stirring handle 16. To allow assembly of stirring handle 16 to stirring utensil stem 18 the stirring handle at the assembles center point is shaped like a “U’ (see FIG. 1 No 32 of stirring handle 16) with the open end being joined together with stirring handle rod 17 clip fitting into circular recess 20 of stirring utensil 18. This fit is allowed due to the varying flexibility of the two parts, handle rod 17 and circular recess 20. It is this assembly which allows for the wide range of movement between the two parts of the stirring apparatus. It is also at this assembly where flexibility, plastic ingredients and contents testing and research is required to insure that sufficient strength is obtained. This area of assembly will be required to carry resistance and weight.

Possible embodiments without illustrations (L) on stirring handle 16 located on the adjacent side of the handle knob, a stopper in the form of a plastic fixed bearing may be moulded into a position which would limit the amount of possible contact and friction from rotating stirring handle 16 the 360 degrees necessary to manually drive the stirring utensil. The shape of the handle may vary from what is shown.

The stirring utensil 18 is shaped like a spoon at the bottom end of the utensil. This spoon shaped end 19 may have perforations in the form of circles or be elongated as illustrated in FIG. 2 No 32 of spoon shaped end 19. Other features of stirring utensil include a bend 33 in the axis of the stirring utensil stem 18 and a flanged ridge 34. The bend 33 allows the axis to be angled allowing the spoon shaped end 19 to reach the pitchers 5 containing wall at the base 8. The flanged ridge 34 positioned above bend 33 of stirring utensil stem positions as a stopper, limiting the vertical rise of stirring utensil stem 18. At the top end of stirring utensil stem 18 is a circular recess 20 which acts as clothes peg fit assemble of stirring handle 16 and stirring utensil stem 18.

Possible embodiments for stirring spoon shaped utensil not clearly illustrated (M) at the circular recess 20 the two open ends may be squared off creating a symmetrical fit for stirring handle “U” shaped contour 32 of stirring handle 16 and circular recess 20 of stirring utensil stem 18. (N) stirring utensil stem 18 from the flanged ridge 34 to circular recess 20 may have a larger circumference intended to allow for increased strength at the assemble of stirring handle rod 17 and circular recess 20. Flange 14 of lid 9 circumference would also need to reflect the possible increase in circumference of stirring utensil stem 18 at proposed location.

The present invention is not limited to a spoon shape utensil. The spoon may be replaced with other stirring type ends to accommodate various uses.

FIGS. 4 and 5 illustrate the handle on the stir jug to be contoured into the lid of the container. The handle is located within a counter bore 40 such that the handle rotates within the counter bore of the lid.

While one embodiment of the present invention has been described in the foregoing, it is to be understood that other embodiments are possible within the scope of the invention. The invention is to be considered limited solely by the scope of the appended claims.

1. A stirring mechanism for a container, the container having an interior for receiving a liquid, comprises:
a lid on a top end of the container;
a hand driven handle on the lid, and;
a contoured stirring member extending from the handle into the container arranged to be driven by the handle within the container for mixing the liquid therein.

2. The mechanism according to claim 1 wherein a raised contour is located within the container on a bottom end therein such that the contoured stirring member is arranged to move about the raised contour.

3. The mechanism according to claim 1 wherein the handle is pivotally mounted.

4. The mechanism according to claim 1 wherein the handle is located within a contoured bore on the lid.
